(19) United States
(12) Patent Application Publication
(10) Pub. No.: US 2012/0268719 A1
(43) Pub. Date: Oct. 25, 2012

(54) POLARIZING BEAM SPLITTER, POLARIZATION CONVERSION ELEMENT USING THE SAME, AND IMAGE PROJECTION APPARATUS

(75) Inventor: Yutaka Yamaguchi, Utsunomiya-shi (JP)

(73) Assignee: CANON KABUSHIKI KAISHA, Tokyo (JP)

(21) Appl. No.: 13/449,055

(22) Filed: Apr. 17, 2012

(30) Foreign Application Priority Data
Apr. 21, 2011 (JP) 2011-095114

(51) Int. Cl. G03B 21/14; G02B 5/30

(52) U.S. Cl. 353/20; 359/489.11

(57) ABSTRACT

A polarizing beam splitter includes a medium and at least two thin-film layers having different refractive indices arranged in order from a light incidence side, and the medium and the thin-film layers satisfy a predetermined mathematical conditions.

### BACKGROUND OF THE INVENTION

1. Field of the Invention

The present invention relates to a polarizing beam splitter, and more particularly, to a polarizing beam splitter having a laminated thin film.

2. Description of the Related Art

In an apparatus for displaying an image using polarization, a polarizing beam splitter that splits incident light into two polarization components perpendicular to each other is used. The polarizing beam splitter is used as a polarization conversion element which converts unpolarized light from a light source into the light having an aligned polarization direction or an element which guides illumination light into a reflection type liquid crystal display device and separates polarized light corresponding to an image light reflected by a reflection type liquid crystal display device from other polarized light.

As an example of a polarizing beam splitter, there is known a so-called “Mac Neil” polarizing beam splitter in which a thin film is laminated on a bonding surface of a prism so as to transmit P-polarized light and reflect S-polarized light by virtue of interference in the thin film using the characteristic of the Brewster's angle. Herein, S-polarized light and P-polarized light may also be referred to as the S-polarization and the P-polarization, respectively, components of a beam of light.

Meanwhile, in International Patent Publication Pamphlet No. WO2001051964A1, there is discussed an element in which metal grids are formed at a minute pitch equal to or smaller than a wavelength of the light so that the polarization vibrating perpendicularly to the grid is transmitted, and the polarization vibrating parallel to the grid is reflected.

In International Patent Publication Pamphlet No. WO2002101427A2, there is discussed a polarizing beam splitter in which films having an anisotropic refractive index are laminated in different anisotropic directions, a difference of the refractive index for the polarization direction is controlled so that one of the polarizations is transmitted, and the other polarization is reflected thereon.

However, since the element discussed in International Patent Publication Pamphlet No. WO2001051964A1 uses a metal material in the grid, absorption may occur due to the metal material during the polarization splitting, which may reduce the light amount.

In addition, in the polarizing beam splitter discussed in International Patent Publication Pamphlet No. WO2002101427A2, it is necessary to laminate a hundred or more film layers in order to obtain practical performance. Since the total number of film layers is significant, the reduction in the light amount caused by optical absorption is not negligible.

### SUMMARY OF THE INVENTION

According to an aspect of the present invention, there is provided a polarizing beam splitter includes a medium and a polarization splitting film formed of at least two thin-film layers having different refractive indices. The medium and the at least two film layers are arranged in order from a light incidence side, in which the following conditional expressions are satisfied:

38°<sin−1(sin(θc)*nH/nb)<52°,

100 nm<ndL<350 nm,

100 nm<ndH/cos(θc)<200 nm, and

θc=cos−1(√(nH²−nL²)/nH),

where nb denotes a refractive index of the medium,

ndH denotes an average value of optical thicknesses nH×dH of the thin-film layers having a refractive index nH where nH is a refractive index and dH is a thickness of a thin-film layer having the highest refractive index out of the thin-film layers,

ndL denotes an average value of optical thicknesses nL×dL of the thin-film layers having a refractive index nL where nL is a refractive index and dL is a thickness of a thin-film layer having the lowest refractive index out of the thin-film layers, and

the average values ndH and ndL are obtained by adding the optical thicknesses of all thin-film layers excluding a layer adjacent to the medium and dividing the sum thereof by the number of thin-film layers.

Further features and aspects of the invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are schematic configuration diagrams illustrating a polarizing beam splitter according to an exemplary embodiment of the present invention.

FIG. 2 is a configuration diagram illustrating a polarizing beam splitter used in a calculation model.

FIG. 3 is a diagram illustrating a relationship between the thickness of an L-layer and a polarization transmittance.

FIGS. 4A, 4B, and 4C are explanatory diagrams illustrating a difference of the characteristic caused by a difference of the thickness of the L-layer.

FIGS. 5A and 5B illustrate a spectral transmittance of a polarizing beam splitter according to a first exemplary embodiment.

FIGS. 6A and 6B illustrate a spectral transmittance of a polarizing beam splitter according to a comparative example.

FIG. 7 is a diagram illustrating a relationship between the transmittance and a light incidence angle of the polarizing beam splitter according to the first exemplary embodiment.

FIG. 8 is a diagram illustrating a relation between the light incidence angle and the transmittance in the polarizing beam splitter according to the comparative example.

FIGS. 9A and 9B illustrate a spectral transmittance of a polarizing beam splitter for a blue wavelength band according to the first exemplary embodiment.

FIGS. 10A and 10B illustrate a spectral transmittance of a polarizing beam splitter for a red wavelength band in the first exemplary embodiment.

FIGS. 11A and 11B illustrate a spectral transmittance of a polarization conversion element according to a second exemplary embodiment.

FIGS. 12A and 12B illustrate a spectral transmittance of a polarization conversion element according to a third exemplary embodiment.

FIGS. 13A and 13B illustrate a spectral transmittance of a polarization conversion element according to a fourth exemplary embodiment.

FIG. 14 illustrates dependence of the incidence angle on the transmittance of the polarization conversion element in the fourth exemplary embodiment.

FIGS. 15A and 15B illustrate a spectral transmittance of a polarization conversion element according to a fifth exemplary embodiment.

FIGS. 16A and 16B illustrate a spectral transmittance of a polarization conversion element according to a sixth exemplary embodiment.

FIG. 17 is a schematic configuration diagram illustrating a polarization conversion element according to a seventh exemplary embodiment.

FIG. 18 is a schematic configuration diagram illustrating an image projection apparatus according to an eighth exemplary embodiment.

FIG. 19 is an explanatory diagram illustrating polarization splitting in the related art.

### DESCRIPTION OF THE EMBODIMENTS

Various exemplary embodiments, features, and aspects of the invention will be described in detail below with reference to the drawings.

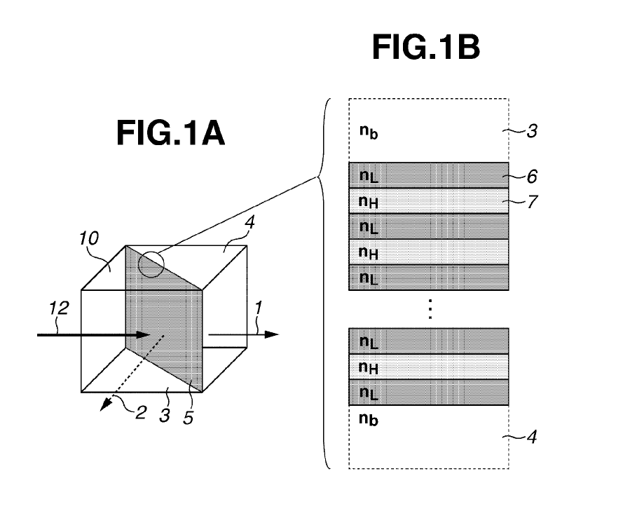

FIG. 1A is a perspective diagram illustrating a polarizing beam splitter 10 according to an exemplary embodiment of the present invention. FIG. 1A illustrates a state in which the polarizing beam splitter 10 splits the incident light 12 into a P-polarized component 1 and an S-polarized component 2. In the polarizing beam splitter 10, a polarizing split film 5 is interposed between prisms 3 and 4 as base material (media). As the incident light 12 including P-polarization (P-polarization component) 1 and S-polarization (S-polarization component) 2 is incident to the polarizing beam splitter 10, the P-polarization 1 transmits through the polarizing split film 5, and the S-polarization 2 is reflected, so that the polarization split is performed.

FIG. 1B is a partially enlarged view illustrating a configuration of the polarizing split film 5. The polarizing split film 5 is formed by alternately laminating a thin film of a low-refractive layer (hereinafter, referred to as an L-layer 6) having a refractive index nL and a high-refractive layer (hereinafter, referred to as an H-layer 7) having a refractive index nH.

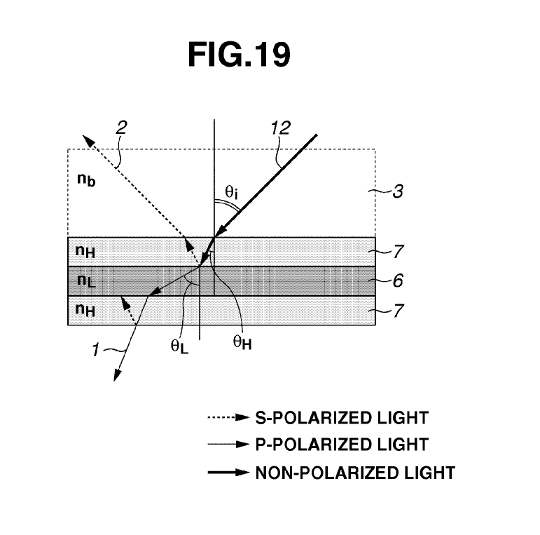

First, for comparison purposes, a polarizing beam splitter for performing the polarization splitting using a Brewster's angle will be described with reference to FIG. 19. FIG. 19 is a schematic diagram illustrating polarization splitting using the Brewster's angle.

First, the light incident at an incidence angle θi to the H-layer 7 having a refractive index nH from the prism 3 having a refractive index nb is refracted or reflected at the interface between the prism 3 and the H-layer 7. An angle of refraction θH in this case may be obtained based on the Snell's law.

Then, the incident light 12 is incident to the L-layer 6 having a refractive index nL (nH>nL) and is refracted at an angle of refraction θL or reflected at an angle of reflection θH in an interface between the H-layer 7 and the L-layer 6. Here, when the angle θH satisfies θH+θL=90°, the condition of the Brewster's angle is satisfied, and reflection of the P-polarization in the interface between the H-layer 7 and the L-layer 6 becomes zero.

In comparison, the reflectance of the S-polarization does not become zero, and nearly overall S-polarization is reflected at an angle θi by repeating the reflection in a plurality of interfaces. If the refractive index nb of the prism, the refractive index nH of the H-layer 7, and the refractive index nL of the L-layer 6 are appropriately selected to satisfy the aforementioned condition for a predetermined incidence angle θi, it is possible to obtain a polarizing beam splitter that transmits the P-polarization and reflects the S-polarization. For example, if θi=45°, nb=1.80, nH=2.40, and nL=1.50, the aforementioned condition is nearly satisfied.

On the other hand, the polarizing beam splitter according to the present exemplary embodiment performs polarization splitting using a difference of the transmittance between the P-polarization and the S-polarization within an angle range where total reflection is generated at the interface without using the Brewster's angle. If the light is incident from the high-refractive layer (H-layer) side to the low-refractive layer (L-layer) side, the angle of refraction is larger than the incidence angle. Therefore, the angle of refraction exceeds 90° for the light incident at an angle equal to or greater than a certain angle (critical angle), so that total reflection is generated, in which overall incident light is reflected.

However, if the thickness of the L-layer is extremely thin, overall light is not reflected even in the total reflection area, and a part of the light transmits through the L-layer. Naturally, the amount of this transmitting light is significantly dependent on the thickness of the L-layer. In addition, the amount of the transmitting light is also significantly dependent on a polarization state of the incident light.

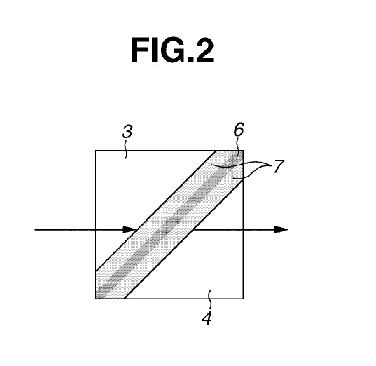

FIG. 2 illustrates a polarizing beam splitter including a prism 3, a high-refractive layer (H-layer 7), a low-refractive layer (L-layer 6), a high-refractive layer (H-layer 7), and a prism 4 arranged in order from the light incidence side.

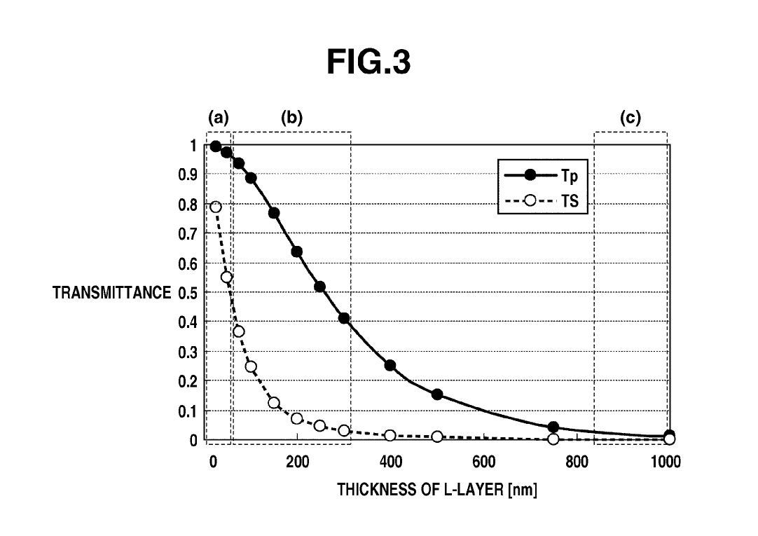

FIG. 3 illustrates a relationship between a transmittance of each polarization and a physical thickness in nanometers (nm) of the L-layer when the light is incident to the H-layer 7 of FIG. 2 at an angle of 45°. In the calculation of the values plotted in FIG. 3, it is assumed that the refractive index nH of the H-layer is 2.4, the thickness dH of the H-layer is about 60 nm, the refractive index nb of the prism 3 is 1.80, and the refractive index nL of the L-layer is 1.25. In this case, the angle of refraction of the light incident to H-layer 7 at an angle of 45° in the L-layer 6 is equal to or greater than 90°, and the condition of the total reflection is satisfied.

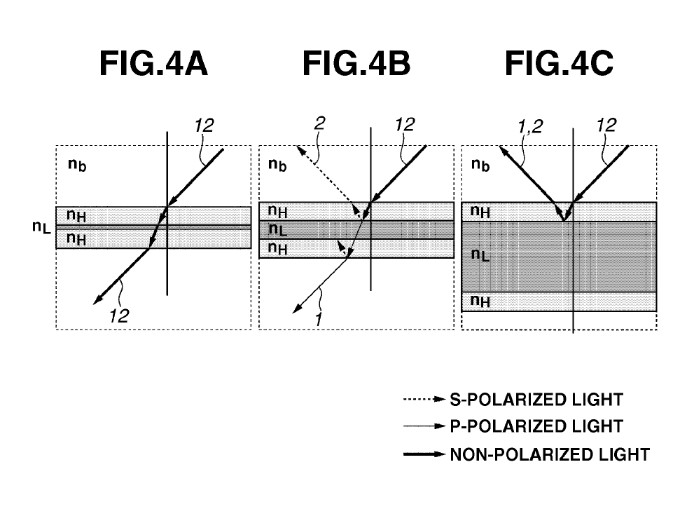

FIGS. 4A, 4B, and 4C are schematic diagrams illustrating a difference of the behavior of the light in the areas A, B, and C having a different physical thickness of the L-layer 6 in FIG. 3. As illustrated in FIG. 4C, if the physical thickness of the L-layer is excessively large (approximately, 820 nm to 1000 nm), overall incident light is reflected without depending on the incidence polarization. Therefore, the transmittance of the incident light becomes nearly zero.

On the other hand, as illustrated in FIG. 4A, if the physical thickness of the L-layer is extremely small, light of any polarization transmits therethrough. However, as illustrated in FIG. 4B, in the range of an appropriate physical thickness of approximately 75 nm to 300 nm, a significant difference is generated between the transmittance of the P-polarization and the transmittance of the S-polarization. Focusing on such a characteristic, it is possible to split the P-polarization and the S-polarization into transmission light and reflection light depending on the polarization direction by combining the H-layer 7 and the L-layer 6 alternately in a repetitive manner.

In addition, it is possible to further increase the transmittance of the P-polarization by setting the optical thickness of the H-layer to approximately λ/4 of the wavelength of light being used, so as to suppress reflection of the P-polarization by using interference. In this manner, it is possible to provide a polarizing beam splitter that can transmits the P-polarization and reflects the S-polarization without using the Brewster's angle by repeatedly laminating the thin film having an appropriate refractive index with an appropriate thickness.

In order to achieve the advantages described above, it is necessary to appropriately select a material (refractive index) or thickness of the thin film, a refractive index of the base material (medium), and other parameters. More specifically, in order to implement the polarizing beam splitter according to the present embodiment, each parameter of the components of the polarizing beam splitter is selected to preferably satisfy the following conditional expressions:

38°<sin⁻¹(sin(θc)*nH/nb)<52° (1)

100 nm<ndL<350 nm (2)

100 nm<ndH/cos(θc)<200 nm (3)

where, θc=cos⁻¹(√(nH²−nL²)/nH) (4)

The expression (1) may be modified to preferably satisfy the following condition:

42°<sin⁻¹(sin(θc)*nH/nb)<48° (1a)

The expression (2) may be modified to preferably satisfy the following condition:

110 nm<ndL<290 nm (2a)

The expression (3) may be modified to preferably satisfy the following condition:

120 nm<ndH/cos(θc)<200 nm (3a)

Here, the angle θc in the expression (4) is a critical angle for the total reflection of incident light within the L-layer. In the polarizing beam splitter according to the present embodiment, it is assumed that the light is incident to the polarizing splitting film of the prism at an angle of approximately 45° as illustrated in FIG. 1A.

The expression (1) expresses a condition for selecting values of nH, nL, and nb to satisfy the critical angle condition for total reflection of incident light within the L-layer when the incidence angle is at approximately 45°. However, it is not necessary to set the value strictly to 45°. It may be slightly variable depending on a design requirement. The advantage of the invention may be obtained even if the value of the incidence angle is set to a range of approximately 38° to 52°.

If the value of the expression (1) is equal to or lower than the lower limit, it is difficult to anticipate the effect of the polarizing beam splitter. If the value of the expression (1) is equal to or higher than the upper limit, polarization splitting may be possible using the Brewster's angle condition, but the angle characteristic becomes sensitive. Therefore, when expression (1) is not satisfied, it is difficult to achieve the advantage of the invention, which is not preferable.

The expression (2) serves to define an appropriate thickness of the L-layers, and more specifically it is indicative of an average value ndL of all L-layers except the L-layer immediately adjacent to the base medium. Herein, the thickness of each L-layer is preferably a physical thickness measured in nanometers, but such thickness may be determined when considering an appropriate optical thickness (a product of the refractive index nL and the physical thickness dL) necessary for appropriate transmission of a first polarized component and reflection of a second polarized component. Specifically, as illustrated in FIG. 3, it is possible to obtain the advantage of the invention by selecting an average value ndL of optical thicknesses nL×dL of the L-layer having the lowest refractive index nL to be included in the range described above.

Here, it is assumed that the average value ndL is obtained by adding the optical thicknesses of all L-layers excluding the outermost L-layer adjacent to the base medium, and dividing the sum by the number of L-layers excluding the L-layer adjacent to the base medium. The reason why the layer adjacent to the base medium is excluded is that there is a possibility that the layer adjacent to the base medium may be significantly deviated from the thickness of the film necessary to obtain the advantage of the invention from the viewpoint of a balance with the anti-reflection effect.

The expression (3) is to define a suitable thickness of the H-layer. The value ndH denotes an average value of the optical thicknesses nH·dH of the H-layer having the highest refractive index nH. The average value ndH in this case is set to a value obtained by adding the optical thickness of each H-layer excluding the H-layer adjacent to the medium (outermost layer), and dividing the sum of optical thicknesses by the number of the H-layers excluding the H-layer adjacent to the medium.

The value ndH/cos(θc) denotes an effective optical path length of the light propagating through the H-layer. If this value is set to approximately λ/4 for a certain wavelength λ of light in the range between 400 nm and 800 nm, it is possible to suppress reflection of the P-polarization and appropriately perform polarization splitting.

Here, the use wavelength range refers to a wavelength range of light for performing polarization splitting (50% or more P-polarization transmits, and 50% or more S-polarization is reflected) using the polarizing beam splitter. If the value ndH is out of the upper limit or the lower limit of the expression (3), the transmittance of the P-polarization may decrease, or the reflectance of the S-polarization may decrease during the polarization splitting. Therefore, performance as the polarizing beam splitter may be degraded.

Each parameter of the expressions (1) to (4) depends on the wavelength due to the refractive index dispersion and the like. However, the expression may be satisfied for a certain wavelength λ within the use wavelength range, and more preferably, for the center wavelength λ0 of the use wavelength range. For example, if the polarizing beam splitter is operated within a range between 450 nm and 650 nm, the aforementioned conditional expression is more preferably satisfied when λ0=550 nm.

Although the conditional expressions necessary to obtain the advantages of the invention have been described hereinbefore, it is necessary, particularly, for the L-layer to have a significantly low refractive index if the polarizing beam splitter satisfies the conditional expression described above, and a material of the base medium is generally glass. If the refractive index nb of the base medium has a range of approximately 1.5 to 2.0, the refractive index nL of the L-layer in the polarizing beam splitter is preferably equal to or lower than 1.30, and the refractive index nH of the H-layer is preferably equal to or higher than 2.0.

In addition, the L-layer is preferably made of an inorganic material from the viewpoint of reliability such as a heat resistance or an anti-UV property. The L-layer may be made of MgF₂, SiO₂, Al₂O₃, or the like, and preferably a dielectric material containing one or more elements of those named above. The H-layer is preferably made of a dielectric material containing metal oxide such as TiO₂, ZrO₂, MgO, Ta₂O₅, Nb₂O₃, and Al₂O₃, or combinations thereof.

If the prism and the thin film are made of an inorganic dielectric material, it is possible to suppress absorption loss. In addition, it is possible to maintain stable performance for a long time even under an environment of a high light intensity.

The polarizing beam splitter according to the invention has a laminated thin-film structure and may be manufactured using various techniques. For example, vapor deposition or sputtering may be generally used to form the film. Although the L-layer preferably has a significantly low refractive index in the aforementioned description, it is possible to provide a low refractive film using a technique of forming a low density film such as an oblique deposition technique even when the refractive index nL of the material used in the L-layer is equal to or higher than 1.30 or even when a typical deposition technique or sputtering is used.

In addition, as a technique of forming a low density film, a sol-gel technique and the like are used. It is possible to manufacture a laminated thin film having a desired thickness by solely using or combining such techniques. Although some of the techniques for forming a laminated thin film have been exemplified, the polarizing beam splitter according to the invention is not limited thereto.

Although a schematic configuration diagram of the polarizing beam splitter having multiple films interposed between the prisms 3 and 4 is illustrated in FIGS. 1A and 1B, both the prisms 3 and 4 are not necessarily provided. Instead, the advantage of the invention may be achieved even when the prism is provided only in the incident light 12 side.

Although both the layer adjacent to the prism 3 of the light incidence side and the layer adjacent to the prism 4 in the side where the P-polarization 1 transmits are the L-layers in FIG. 1B, only one of them may be the L-layer. According to the invention, it is possible to provide a polarizing beam splitter capable of optimizing the transmission of a first polarization component and the reflection of a second polarization component orthogonal to the first component.

Now, the polarizing beam splitter according to a first exemplary embodiment of the present invention will be described. In the first exemplary embodiment, three design examples will be described for three (red, green, and blue) wavelength bands.

First, Table 1 illustrates the design values and the values of conditional expressions in the polarizing beam splitter to be operated under the green wavelength band. A schematic configuration of the polarizing beam splitter is similar to that illustrated in FIGS. 1A and 1B, and description thereof will not be repeated. A structure obtained by laminating a thin film including the H-layer 7 (nH=2.39) and the L-layer 6 (nL=1.25) 11 times is interposed between two rectangular prisms (nb=1.805).

As a material of the film having such refractive indices, the H-layer may be made of TiO₂ or a combination of TiO₂ and ZrO₂, and the L-layer may be a low density SiO₂ layer, and the like. In the case of SiO₂, if a ratio between the air and SiO₂ is set to 44:56, it is possible to obtain a layer having a refractive index of approximately nL=1.25. The bonding layer of Table 1 refers to a layer for bonding the polarizing beam splitter and one of the rectangular prisms. In this configuration, the optical characteristic is maintained even when the incident light is incident from any interface of the polarizing splitting film.

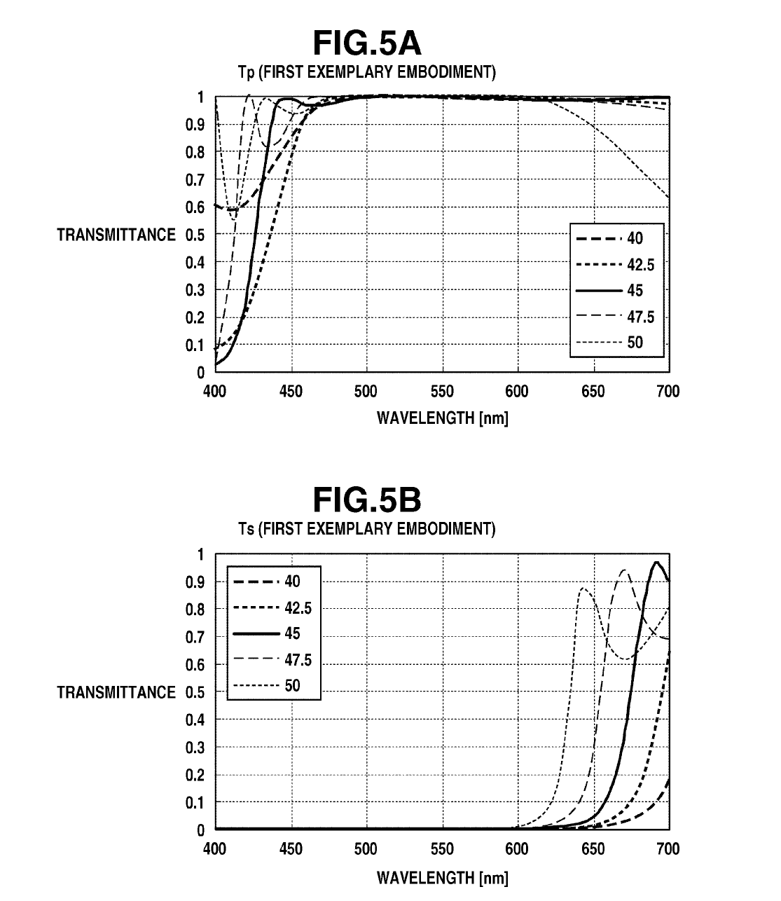

The P-polarization transmittance is illustrated in the first exemplary embodiment of FIG. 5A, and S-polarization transmittance is illustrated in FIG. 5B, where Tp denotes a P-polarization transmittance, and Ts denotes an S-polarization transmittance. The plot types in the drawings are differently set depending on the incidence angle of the light to the polarizing splitting film. The inset in FIGS. 5A and 5B illustrate the incidence angle of the light incident on the polarizing splitting film.

Here, as a comparative example, design values and the conditional expressions (1) to (3) of the polarizing beam splitter fora green wavelength band using the Brewster's angle of the related art are referred in Table 2. Although the first exemplary embodiment of Table 1 satisfies each conditional expression (1) to (3), a comparative example 1 of Table 2 is designed in such a manner that the Brewster's angle of the incidence angle is set to approximately 45°. Therefore, the value of the conditional expression (1) becomes 54.5°, and this does not satisfy the expression (1).

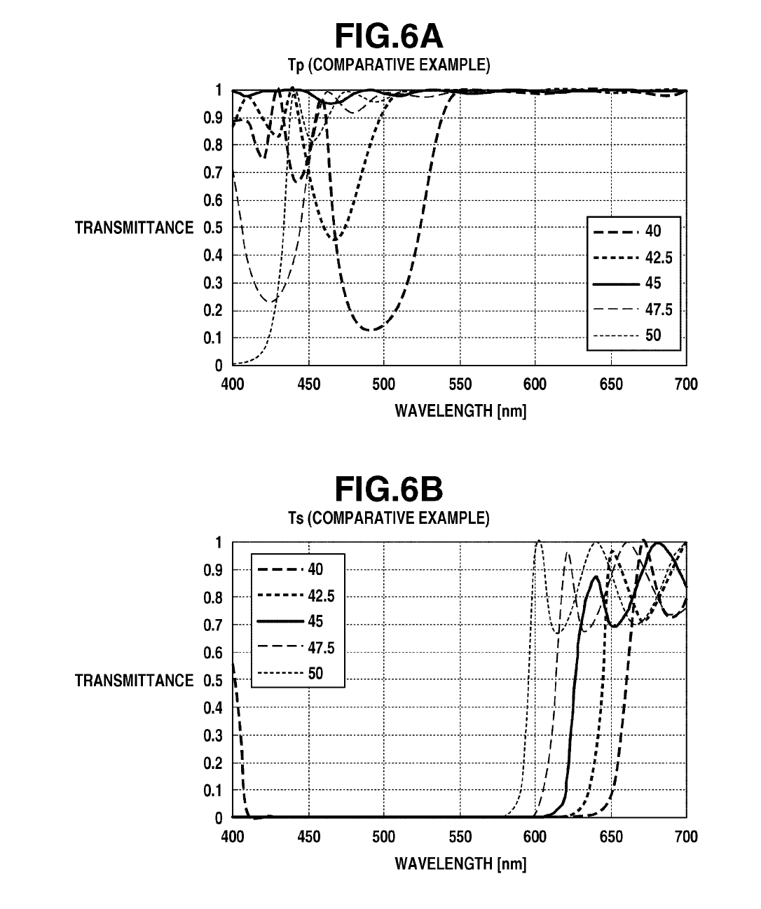

FIGS. 6A and 6B illustrate spectral transmittances of the P-polarization and the S-polarization in the comparative example 1. Comparing FIGS. 5A and 5B, and 6A and 6B respectively, there is a difference, particularly, in the characteristic of the P-polarization. In the comparative example 1, as shown in FIG. 6A, since the Brewster's angle is used, if the incidence angle is deviated from approximately 45°, the transmittance of the P-polarization is abruptly degraded.

On the other hand, as shown in FIG. 5A, the polarizing beam splitter according to the present invention maintains a high P-polarization transmittance even when the incidence angle is changed. In addition, since the exemplary embodiment of the present invention is implemented by using a half number of the layers, compared to the comparative example 1, it is possible to alleviate reduction of the amount of light transmitted.

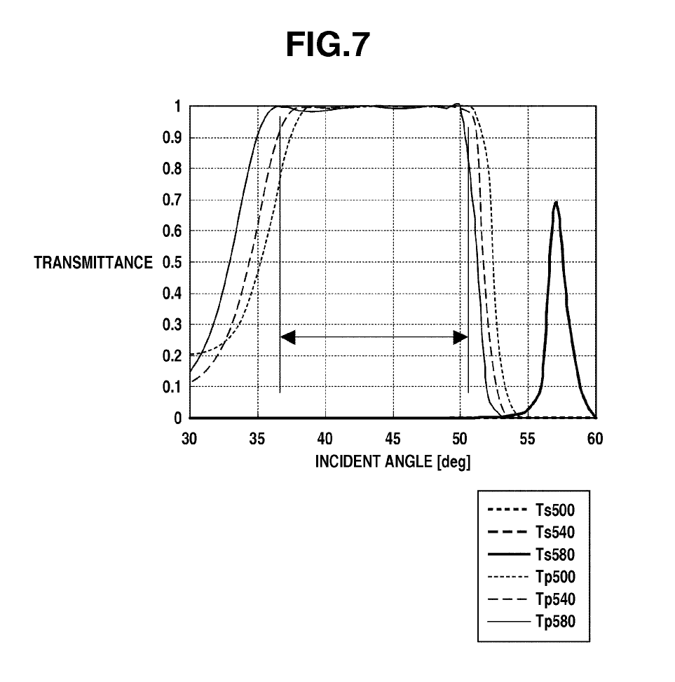

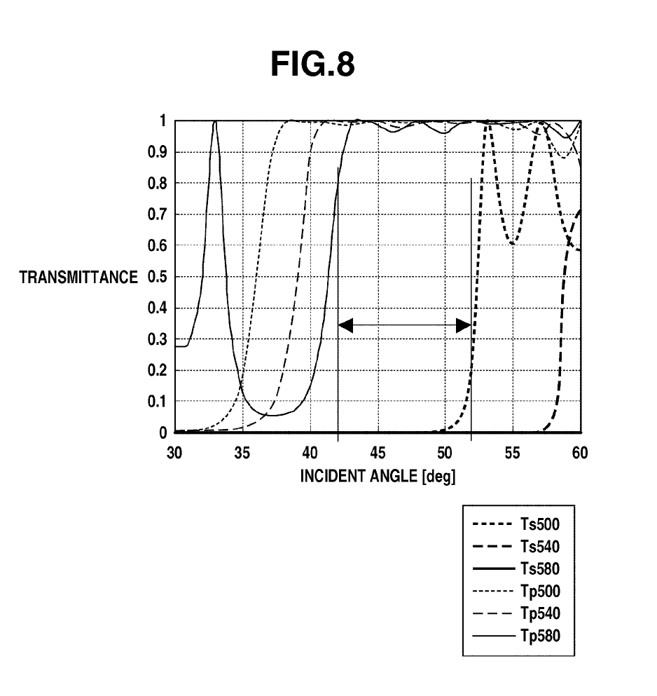

FIG. 7 is a diagram illustrating a relationship between the transmittance of polarized light and the incidence angle of light incident on the polarizing beam splitter according to the first exemplary embodiment. Tp and Ts of the legends denote the P-polarization transmittance and the S-polarization transmittance, respectively. The plot types are differently set depending on the wavelength. A similar diagram is illustrated in FIG. 8 for the comparative example 1.

Comparing the angle ranges (indicated by the double ended arrow) where the P-polarization transmittance Tp is high (equal to or higher than 80%), and the S-polarization transmittance Ts is low (equal to or lower than 20%) between two drawings, the range of FIG. 7 is wider than that of FIG. 8. In other words, the polarizing beam splitter according to the first exemplary embodiment of the present invention can provide a high light detection capability in a wider incidence angle range than the related art. In addition, it is possible to obtain a desired polarization splitting capability with a small number of layers in the film.

Although the example of Table 1 shows a polarizing beam splitter for the green wavelength band, it can be applicable to the blue wavelength band and the red wavelength band by changing the thickness of the layer. Table 3 shows design values of the polarizing beam splitter for the blue wavelength band according to the first exemplary embodiment and the values of the conditional expressions (1) to (3). Table 4 similarly shows an example for the red wavelength band. In either table, each conditional expression is satisfied.

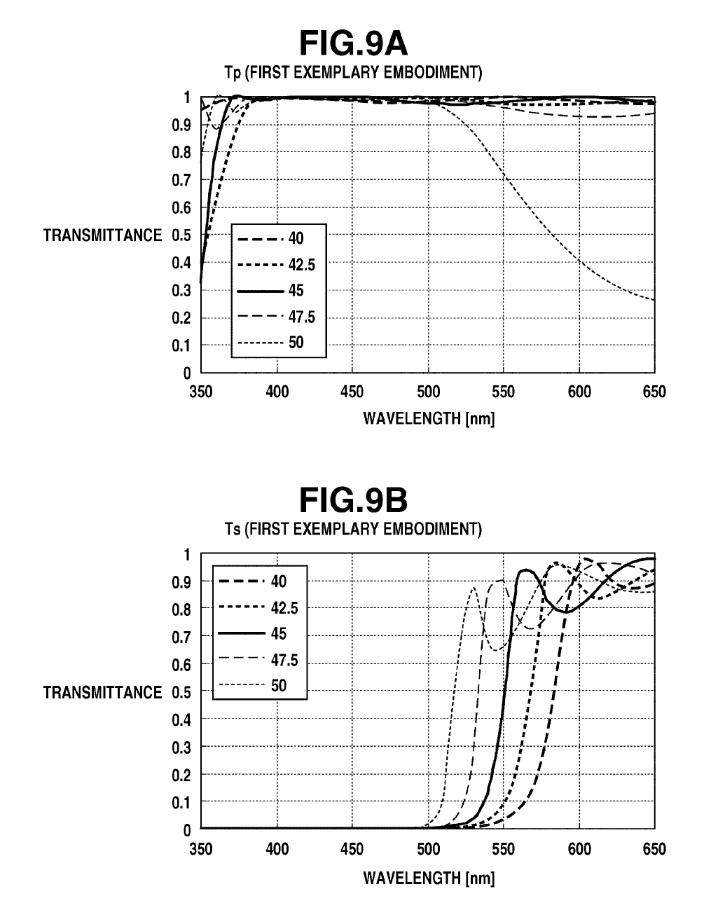

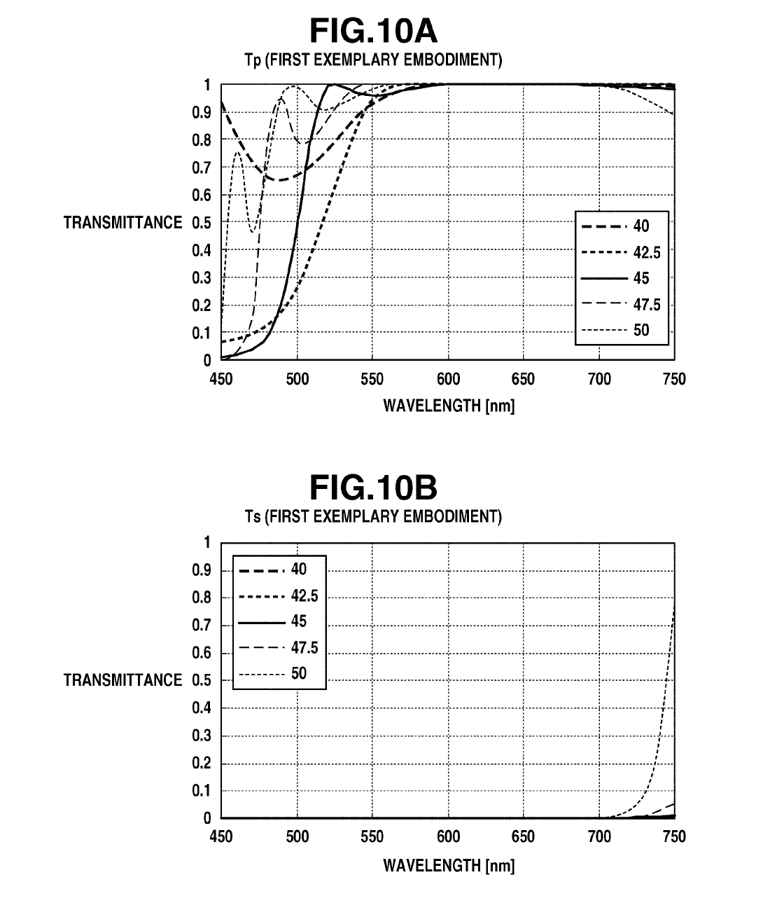

Similar to FIG. 7, FIGS. 9A and 9B illustrate a spectral transmittance of the polarizing beam splitter for the blue wavelength band of Table 3. FIGS. 10A and 10B illustrate a spectral transmittance of the polarizing beam splitter for the red wavelength band of Table 4. As apparent from FIGS. 7, 9A, 9B, 10A, and 10B, the polarizing beam splitter for each band in the first exemplary embodiment exhibits an excellent P-polarization transmittance with a wavelength bandwidth of approximately 100 nm even when the wavelength band is changed. That is, the polarization conversion element according to the invention has a more excellent angle characteristic for the polarizing beam splitter of the related art which uses the Brewster's angle, without depending on the wavelength range.

Next, Table 5 shows design values and values of the conditional expressions (1) to (3) of the polarizing beam splitter according to a second exemplary embodiment. The design wavelength of the polarizing beam splitter of the second exemplary embodiment is set to 540 nm, and the excellent performance is obtained, particularly, in the green wavelength band.

In the polarizing beam splitter according to the second exemplary embodiment, the refractive index nb of the prism as a base medium is set to 1.6. The refractive index of the low refractive layer lowers from 1.25 to 1.176 accordingly so that it is possible to satisfy each conditional expression and obtain similar performance with the same number of layers as that of the first exemplary embodiment. If the L-layer is a low density SiO₂ layer, the ratio between the air and SiO₂ is set to 60:40. As a result, it is possible to implement a low refractive index.

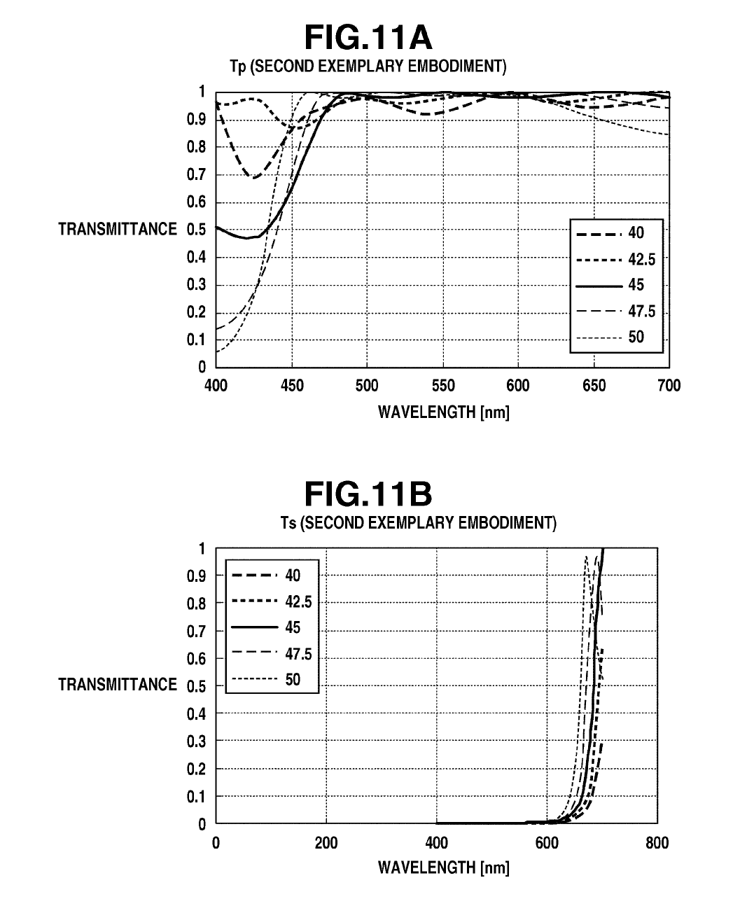

FIGS. 11A and 11B illustrate a spectral transmittance of the polarizing beam splitter according to the second exemplary embodiment. It is recognized that an excellent polarization splitting characteristic is obtained by suppressing reduction of the transmittance within a wide angle range, particularly, in the P-polarization even when the refractive index of the prism decreases to 1.6.

Next, Table 6 shows design values and values of the conditional expressions (1) to (3) of the polarizing beam splitter according to a third exemplary embodiment. The design wavelength is set to 540 nm.

Similar to the second exemplary embodiment, in the polarizing beam splitter according to the third exemplary embodiment, the refractive index nb of the prism as a base medium is set to 1.6, and the same material and the same number of layers as those of the second exemplary embodiment are used. However, the film thickness is different. In the third exemplary embodiment, comparing with the second exemplary embodiment regarding the values of the conditional expression, the conditional expression (2) corresponds to a lower limit set, and the conditional expression (3) corresponds to an upper limit set by changing the thicknesses of the H-layer and the L-layer. However, each conditional expression is satisfied.

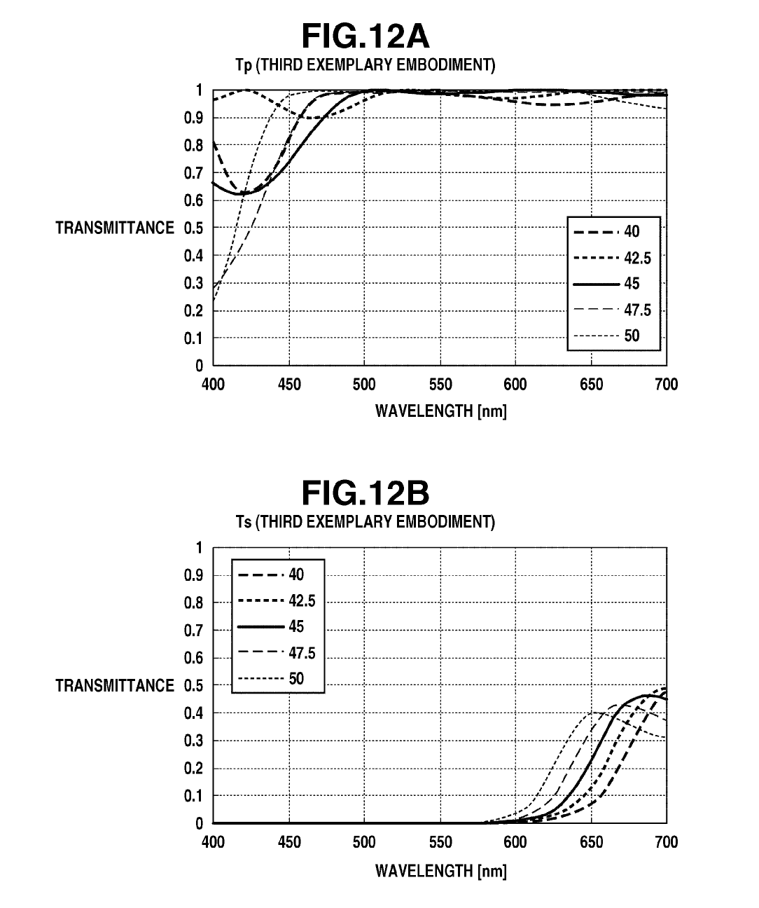

FIGS. 12A and 12B illustrate a spectral transmittance of the polarizing beam splitter of the third exemplary embodiment. Similarly, it is recognized that an excellent polarization splitting characteristic is obtained without degrading the transmittance within a wide angle range for the P-polarization as well as the reflection of the S-polarization using the polarizing beam splitter of the third exemplary embodiment.

In this manner, it is recognized that an excellent polarization splitting characteristic is obtained if the elements of the polarizing beam splitter satisfy the range of the conditional expression even when that value is slightly deviated from the center value of the conditional expression.

Next, Table 7 shows design values and the values of the conditional expressions (1) to (3) of the polarizing beam splitter according to a fourth exemplary embodiment. The polarizing beam splitter of the fourth exemplary embodiment has a structure in which a laminated thin film including 17 layers is interposed between the rectangular prisms having a refractive index nb of 1.60.

Comparing with the first to third exemplary embodiments described above, the polarizing beam splitter can exhibit an excellent polarization splitting characteristic within a wider wavelength band like white light by increasing the number of layers from 11 to 17. The refractive index nL of the low refractive layer is set to 1.176, and the refractive index nH of the high refractive layer is set to 2.39, so that each conditional expression of the polarizing beam splitter of the fourth exemplary embodiment is satisfied as shown in Table 7.

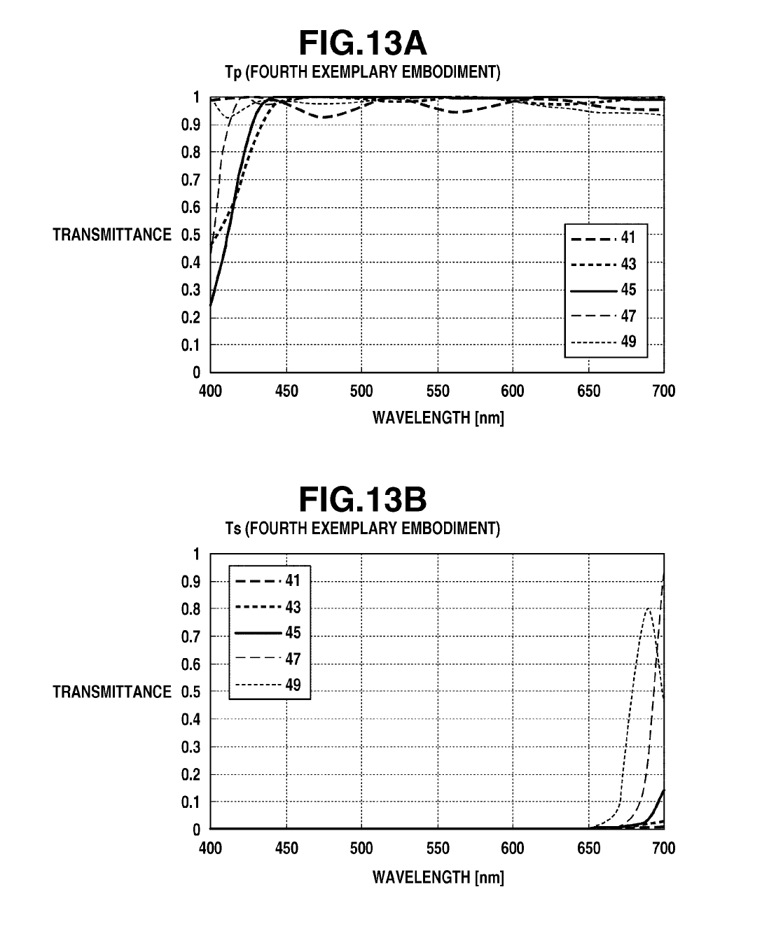

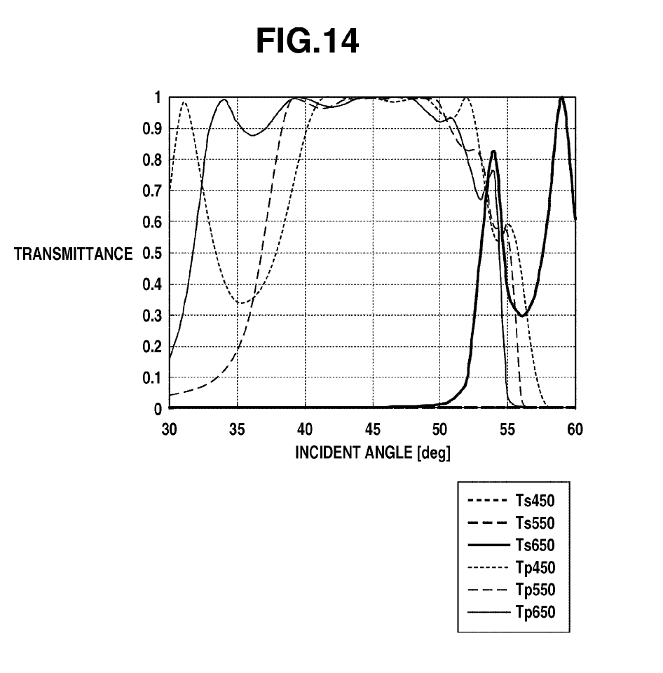

FIGS. 13A and 13B illustrate a spectral transmittance of the polarizing beam splitter according to the fourth exemplary embodiment. From FIGS. 13A and 13B, it is recognized that the polarizing beam splitter of the fourth exemplary embodiment exhibits an excellent polarization splitting characteristic within a wide wavelength range of 450 nm to 650 nm. Similar to FIG. 7, FIG. 14 illustrates a relation between the incidence angle and the transmittance of the polarizing beam splitter in the fourth exemplary embodiment.

From FIG. 14, it is recognized that an excellent polarization splitting characteristic is obtained for the wavelength of 450 nm to 650 nm within an incidence angle range of 40° to 50°. In this manner, according to the fourth exemplary embodiment, compared to the related art, it is possible to obtain the polarizing beam splitter with both the wide range characteristic and the wide angle characteristic.

Next, Table 8 shows design values and values of the conditional expressions (1) to (3) of the polarizing beam splitter according to a fifth exemplary embodiment. The polarizing beam splitter of the fifth exemplary embodiment has a structure in which the laminated thin film is interposed between rectangular prisms having a refractive index nb of 1.80, which is higher than that of the fourth exemplary embodiment. Accordingly, the refractive index nL of the low refractive layer is set to 1.20, and the refractive index nH of the high refractive layer is set to 2.39, so that the polarizing beam splitter of the fifth exemplary embodiment satisfies each conditional expression.

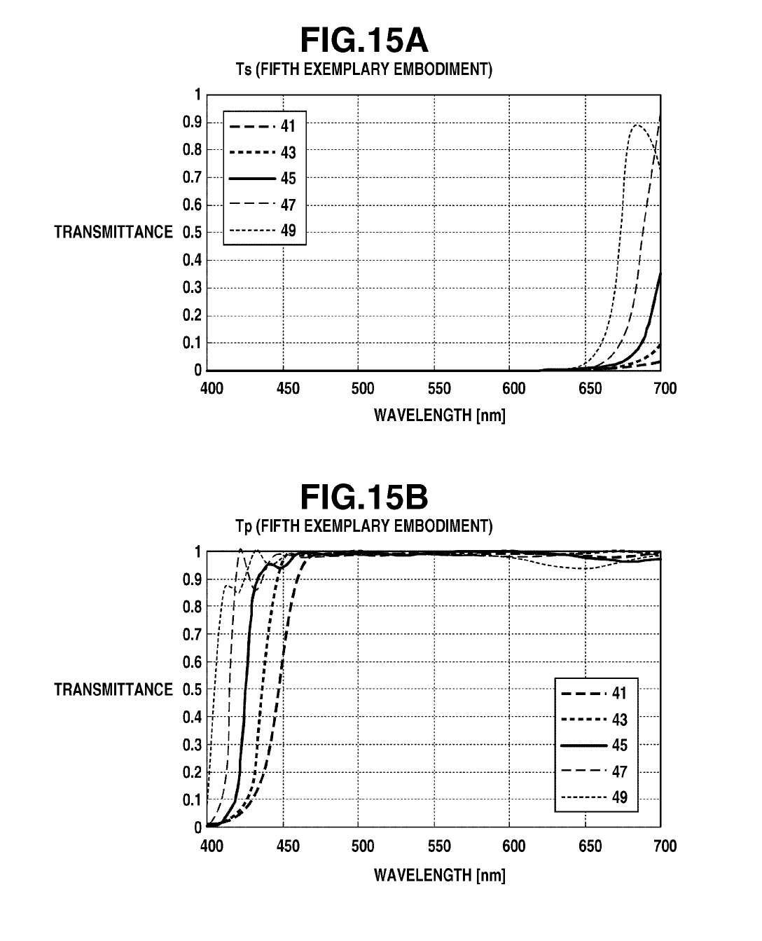

FIGS. 15A and 15B illustrate a spectral transmittance of the polarizing beam splitter according to the fifth exemplary embodiment. From the fifth exemplary embodiment, it is also recognized that an excellent polarization splitting characteristic is obtained within a wavelength range of 450 nm to 650 nm.

Next, Table 9 shows design values and values of the conditional expressions (1) to (3) of the polarizing beam splitter according to a sixth exemplary embodiment. The polarizing beam splitter according to the sixth exemplary embodiment has a structure in which a laminated thin film including three types of layers having different refractive indices is interposed between rectangular prisms having a refractive index nb of 1.71.

By appropriately interposing the layer having a refractive index n of 1.62 between the low refractive layer (nL=1.176) and the high refractive layer (nH=2.39), it is possible to improve angle dependence or appropriately suppress a ripple in the transmittance or the reflectance. The polarizing beam splitter according to the sixth exemplary embodiment satisfies each conditional expression.

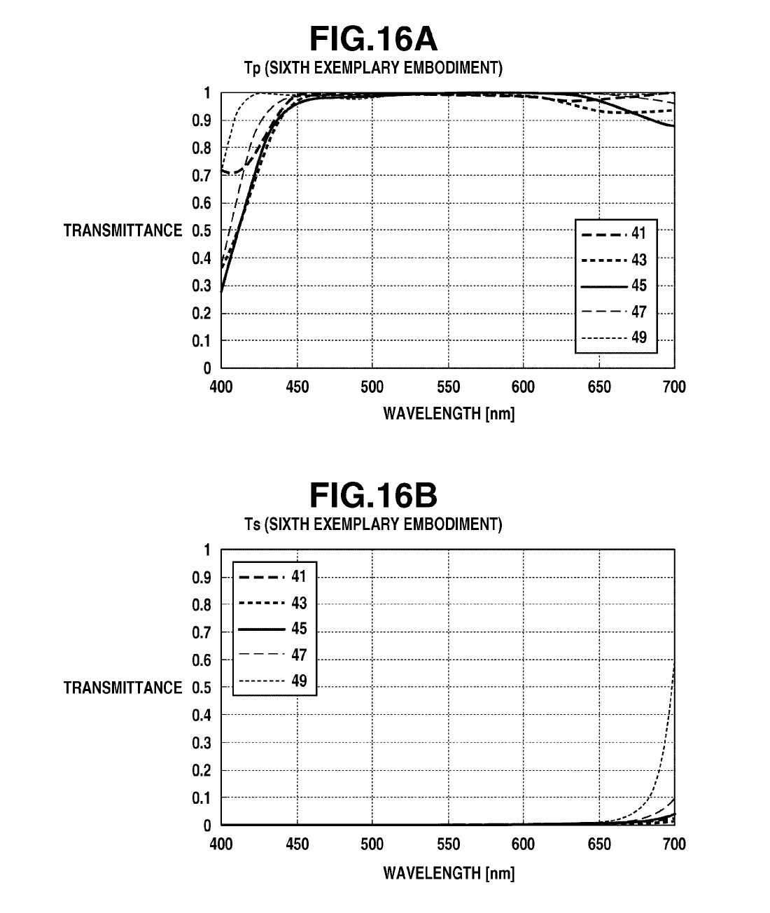

FIGS. 16A and 16B illustrate a spectral transmittance of the polarizing beam splitter of the sixth exemplary embodiment. Even when three or more types of film materials are used as in the sixth exemplary embodiment, it is possible to obtain an excellent polarization splitting characteristic within a wavelength range of 450 nm to 650 nm.

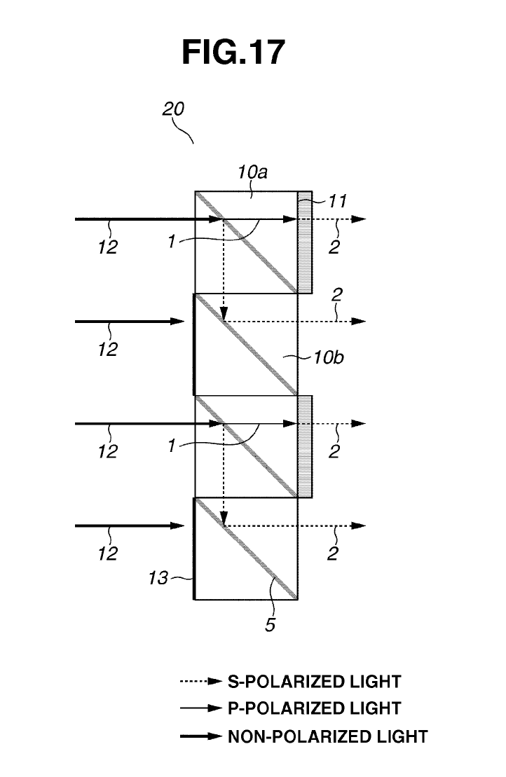

Next, a polarization conversion element according to a seventh exemplary embodiment of the present invention will be described. FIG. 17 is a schematic configuration diagram illustrating the polarization conversion element 20. The polarization conversion element is an element for converting the unpolarized incident light into polarized light having a same polarization direction.

As the unpolarized incident light 12 (represented as a mixture of the P-polarization 1 and S-polarization 2) is incident to the polarizing beam splitter 10a, the P-polarization transmits through the polarizing split film 5, and the S-polarization 2 is reflected at polarizing split film 5. The P-polarization 1 transmitting through the polarizing split film 5 further transmits through the λ/2 wave plate 11 provided in the output side.

The λ/2 wave plate 11 has a function of rotating the polarization direction of the incident light by 90°. Therefore, the incident P-polarization 1 is converted into the S-polarization 2 and then output. In addition, the S-polarization reflected at the polarizing split film 5 is reflected at the polarizing beam splitter 10b again, and is output in the same direction as that of the S-polarization transmitting through the λ/2 wave plate 11.

The light incident to the polarizing beam splitter 10b from the light incidence side of the polarization conversion element 20 is reflected at the light shielding portion 13, and is returned to a lamp unit (not illustrated). As a result, the unpolarized incident light 12 incident to the polarization conversion element 20 is aligned and output as the S-polarization 2. The polarization conversion element preferably has a small loss and a high degree of polarization (in this example, a ratio between the S-polarization and the P-polarization in the output light) of the output polarization.

However, in the polarizing beam splitter of the related art, since the angle range within which the polarization can be appropriately split is narrow, the degree of polarization was easily degraded. In addition, the degree of polarization was further degraded when the polarizing beam splitter is used in a wide wavelength range.

In this regard, if the polarizing beam splitter, for example, according to the fourth or fifth exemplary embodiment of the present invention is used in the polarizing beam splitter 10a and 10b, the polarization is appropriately split within a wide wavelength range of nearly the entire visible light. Therefore, it is possible to improve the degree of polarization.

In addition, as another advantage, it is possible to appropriately perform the polarization splitting for a wide incidence angle. Therefore, it is possible to suppress degradation of the degree of polarization even when the parallelism of the incident light is low. Naturally, even using the polarizing beam splitter of the first to third exemplary embodiments, it is possible to provide a polarization conversion element with little dependence on the incidence angle change.

Although the polarization conversion element for aligning the polarization to the S-polarization has been described in the present exemplary embodiment, it may be possible to use a polarization conversion element capable of aligning the polarization state in an arbitrary direction such as P-polarization or left or right circular polarization by changing the arrangement place of the λ/2 wave plate 11 or changing the phase difference from λ/2 to λ/4. That is, the present invention is not limited to the type of the polarization conversion element of the examples.

In addition, the λ/2 wave plate 11 preferably has an approximately constant phase difference across the entire used wavelength range. As such a wave plate, there is known a wave plate having a film laminated to control the extension direction. In addition, the wave plate is preferably made of an inorganic material.

For example, it is possible to manufacture a wave plate having an approximately constant phase difference across the entire used wavelength range by laminating inorganic dielectric crystals or setting the fine periodic structure equal to or smaller than the wavelength with an appropriate period and an appropriate structure width.

In addition, if a phase compensation plate for compensating for a deviation of the phase or the polarization axis caused by the incidence angle is arranged in the incidence side or the output side of the polarizing beam splitter 10a or 10b, it is possible to align the output polarization direction in a constant direction without depending on the incidence angle, which is preferable.

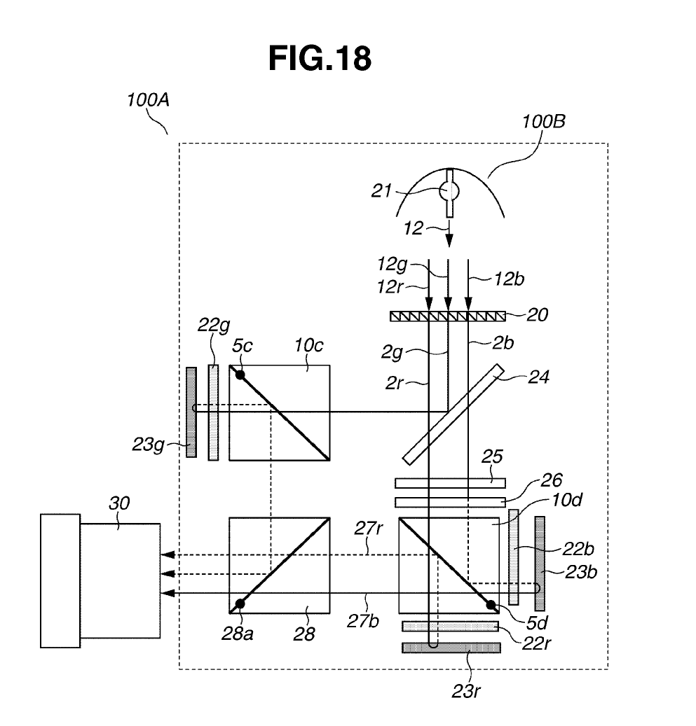

Next, an image projection apparatus using an image display device (reflection type liquid crystal display device) according to an eighth exemplary embodiment of the present invention will be described. FIG. 18 is an example schematic configuration diagram illustrating an image projection apparatus 100A. The light irradiated from the light source 21 of the image projection apparatus 100 is reflected at a reflector, collimated into approximately parallel light, and are incident to the polarization conversion element 20.

In FIG. 18, the incident light (white parallel light) 12 is illustrated as three divided primary-color (green, blue, and red) light including green light 12g, blue light 12b, and red light 12r. Although the green light 12g, the blue light 12b, and the red light 12r are spatially separated in FIG. 18 for simplicity, the three color light beams are not spatially separated in this stage. Hereinafter, green, blue, and red colors are denoted by G, B, and R, respectively.

The light of each color emitted from the light source 21 transmits through the polarization conversion element 20 and is aligned in the polarization direction so as to provide Green polarized light 2g, B polarized light 2b, and R polarized light 2r. Then, the different color of polarized are incident to the dichroic mirror 24.

The dichroic mirror 24 has a characteristic that reflects only the G polarized light 2g. The G polarized light 2g is reflected, and the R polarized light 2r and B polarized light 2b transmit through the dichroic mirror 24, so that the G polarized light is chromatically separated. The G polarized light 2g is directly incident to the polarizing beam splitter 10c, transmits through the polarization splitting film 5c and then the wave plate 22g, and is incident to the G image display device 23g.

Since the R polarized light 2r and the B polarized light 2b transmit through the polarization plate 25, they are incident to the wavelength-selective wave plate 26 while the degree of polarization is improved. The wavelength-selective wave plate 26 converts only the polarization direction of the B polarized light 2b by 90°. As a result, the B polarized light 2b and the R polarized light 2r are incident to the polarizing beam splitter 10d while only the polarization direction of the B polarized light 2b is rotated by 90°, and the polarization state of the R polarized light 2r is maintained.

The B polarized light 2b is reflected at the polarization splitting film 5d of the polarizing beam splitter 10d, transmits through the wave plate 22b, and is incident to the B image display device 23b. The R polarized light 2r transmits through the polarization splitting film 5d and the wave plate 22r, and is incident to the R image display device 23r.

The polarization state of the light incident to the image display devices 23b, 23r, and 23g is changed for each pixel according to the image signal, and the light becomes image light by reflection. The image light refers to the polarized light guided to the projection lens 30 side by the polarizing beam splitter 10c or 10d out of the light of which the polarization state is changed by the image display device.

In addition, the wave plates 22g, 22b, and 22r correct the phase deviation generated by the polarizing beam splitter and the image display device to reduce an optical loss which degrades contrast during black display.

The B and R image light reflected by the image display devices 23b and 23r transmits through the wave plates 22b and 22r again, and is incident to the polarizing beam splitter 10d again. The B image light 27b transmitting through the polarization splitting film 5d and the R image light 27r reflected by the polarization splitting film 5d are output from the polarizing beam splitter 10d and incident to the synthesizing prism 28.

The G image light reflected by the image display device 23g also transmits through the wave plate 22g, is reflected by the polarization splitting film 5c of the polarizing beam splitter 10c, and is incident to the synthesizing prism 28. The G image light is reflected by the dichroic film 28a of the synthesizing prism 28, and the R image light 27r and the B image light 27b transmit through the dichroic film 28a so that the G light, the R light, and the B light are synthesized. The image light synthesized by the synthesizing prism 28 is projected onto a screen (projection target surface) using a projection lens 30 (optical projection system).

Although the polarizing beam splitter of the first exemplary embodiment is used in the polarizing beam splitter 10c, and the polarizing beam splitter of the fourth or fifth exemplary embodiment is used in the polarizing beam splitter 10d or the polarization conversion element 20 in the image projection apparatus of the eighth exemplary embodiment, it is not limited thereto.

It is possible to obtain the advantage of the present invention and a bright projection image if any one of examples is used. In addition, it is possible to improve contrast using the polarizing beam splitter according to the exemplary embodiments.

If the reflection type image display device is used as in the eighth exemplary embodiment, the polarizing beam splitter separates the image light and the non-image light from the image display device. For this reason, the characteristic of the polarizing beam splitter directly influences quality of the display image.

For example, if the polarization splitting characteristic is not sufficient, the p-polarization to be reflected by the image display device, transmit through the polarization splitting film 5c, and be returned to the light source side, is partially reflected in the G light path. As a result, even non-image light is directed to the projection lens side, which degrades contrast.

The light to be incident from the dichroic mirror 24 to the polarizing beam splitter 10b, transmit through the polarization splitting film 5c, and illuminate the image display device, is reflected by the polarization splitting film 5c. Therefore, the light amount and the luminance of the display image decrease. In this manner, in the image projection apparatus where high brightness and high contrast are demanded, quality of the projection image significantly depends on the characteristic of the polarizing beam splitter.

If the polarizing beam splitter according to the present invention is used in such an image projection apparatus, it is possible to provide an image projection apparatus capable of providing high luminance and high contrast, and displaying high quality image.

As another example, if the polarization conversion element according to the present invention is applied to the image projection apparatus using a transmission type image display apparatus (liquid crystal display device), the degree of polarization is improved. In addition, since reduction of the light amount can be alleviated, it is possible to obtain a bright projection image.

Although the optical system of FIG. 18 is divided into the single G light path and the common R and B optical path using the dichroic mirror 24 and the wavelength-selective wave plate 26, the optical system may be divided into the single R optical path and the common B and G optical path or into the single B optical path and the common R and G optical path according to the characteristics of the wavelength-selective wave plate 26.

Alternatively, although the optical system may be individually divided into the R optical path, the G optical path, and the B optical path without using the wavelength-selective wave plate 26, the chromatic separation/synthesizing system is not limited to the configuration of the exemplary embodiments. Even in any chromatic separation/synthesizing system, it is possible to obtain the same advantages as those described above by appropriately using the polarizing beam splitter of the first to fifth exemplary embodiments of the present invention. In addition, the arrangement place of each image display device may be appropriately changed.

In addition, the invention is not limited to the light source that emits white light. Instead, a laser light source capable of emitting polarized light may be used. Although description according to the eighth exemplary embodiment has been made for the image projection apparatus including a projection lens, the advantage of the invention may be obtained even by using an image projection apparatus body 100B that does not include a projection lens.

TABLE 1
First exemplary embodiment (green wavelength band)

| | | | |
|---|---|---|---|
| nb | 1.805 | θc | 31.5 |
| nH | 2.39 | Expression (1) | 43.8 |
| nL | 1.25 | Expression (2) | 207.4 |
| Bonding layer | 1.55 | Expression (3) | 169.143 |

| | d | nd |
|---|---|---|
| Substrate | — | — |
| L | 66.2 | 82.8 |
| H | 64 | 153.0 |
| L | 151.4 | 189.3 |
| H | 59.6 | 142.4 |
| L | 175.3 | 219.1 |
| H | 58.2 | 139.1 |
| L | 176.5 | 220.6 |
| H | 59.2 | 141.5 |
| L | 160.5 | 200.6 |
| H | 60.6 | 144.8 |
| L | 75.1 | 93.9 |
| Bonding layer | — | — |
| Substrate | — | — |

TABLE 2
Comparative example 1 (green wavelength band)

| | | | |
|---|---|---|---|
| nb | 1.805 | θc | 38.0 |
| nH | 2.39 | Expression (1) | 54.5 |
| nL | 1.47 | Expression (2) | 180.8 |
| Bonding layer | 1.55 | Expression (3) | 169.7 |

| | d | nd |
|---|---|---|
| Substrate | — | — |
| H | 60 | 143.4 |
| L | 63 | 92.6 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 143 | 210.2 |
| H | 55 | 131.5 |
| L | 63 | 92.6 |
| H | 60 | 143.4 |
| Bonding layer | — | — |
| Substrate | — | — |

TABLE 3
First exemplary embodiment (blue wavelength band)

| | | | |
|---|---|---|---|
| nb | 1.805 | θc | 30.9 |
| nH | 2.47 | Expression (1) | 44.7 |
| nL | 1.27 | Expression (2) | 185.9 |
| Bonding layer | 1.55 | Expression (3) | 125.8 |

| | d | nd |
|---|---|---|
| Substrate | — | — |
| L | 60.8 | 77.2 |
| H | 46.6 | 115.1 |
| L | 134.5 | 170.8 |
| H | 43.1 | 106.5 |
| L | 155.4 | 197.4 |
| H | 42 | 103.7 |
| L | 155.6 | 197.6 |
| H | 42.8 | 105.7 |
| L | 139.9 | 177.7 |
| H | 44 | 108.7 |
| L | 66.7 | 84.7 |
| Bonding layer | — | — |
| Substrate | — | — |

TABLE 4
First exemplary embodiment (red wavelength band)

| | | | |
|---|---|---|---|
| nb | 1.805 | θc | 32.7 |
| nH | 2.35 | Expression (1) | 44.7 |
| nL | 1.27 | Expression (2) | 280.2 |
| Bonding layer | 1.55 | Expression (3) | 189.4 |

| | d | nd |
|---|---|---|
| Substrate | — | — |
| L | 92.7 | 117.7 |
| H | 72.5 | 170.4 |
| L | 206.1 | 261.7 |
| H | 66.4 | 156.0 |
| L | 231.6 | 294.1 |
| H | 65 | 152.8 |
| L | 232.4 | 295.1 |
| H | 66.2 | 155.6 |
| L | 212.4 | 269.7 |
| H | 69 | 162.2 |
| L | 99.2 | 126.0 |
| Bonding layer | — | — |
| Substrate | — | — |

TABLE 5
Second exemplary embodiment

| | | | |
|---|---|---|---|
| nb | 1.6 | θc | 29.5 |
| nH | 2.39 | Expression (1) | 47.3 |
| nL | 1.176 | Expression (2) | 180.2 |
| Bonding layer | 1.55 | Expression (3) | 137 |

| | d | nd |
|---|---|---|
| Substrate | — | — |
| H | 56 | 134 |
| L | 92 | 108 |
| H | 45.8 | 109 |
| L | 201.9 | 237 |
| H | 52.1 | 125 |
| L | 196.8 | 231 |
| H | 54.3 | 130 |
| L | 184.5 | 217 |
| H | 47.4 | 113 |
| L | 91.1 | 107 |
| H | 58.6 | 140 |
| Bonding layer | — | — |
| Substrate | — | — |

TABLE 6
Third exemplary embodiment

| | | | |
|---|---|---|---|
| nb | 1.6 | θc | 29.5 |
| nH | 2.39 | Expression (1) | 47.3 |
| nL | 1.176 | Expression (2) | 119.0 |
| Bonding layer | 1.55 | Expression (3) | 193.8 |

| | d | nd |
|---|---|---|
| Substrate | — | — |
| H | 178.7 | 427 |
| L | 84.4 | 99 |
| H | 55.8 | 133 |
| L | 144.9 | 170 |
| H | 74.4 | 178 |
| L | 79.8 | 94 |
| H | 83.9 | 201 |
| L | 119.5 | 141 |
| H | 68.2 | 163 |
| L | 77.2 | 91 |
| H | 122.3 | 292 |
| Bonding layer | — | — |
| Substrate | — | — |

TABLE 7
Fourth exemplary embodiment

| | | | |
|---|---|---|---|
| nb | 1.6 | θc | 29.5 |
| nH | 2.39 | Expression (1) | 47.3 |
| nL | 1.176 | Expression (2) | 160.0 |
| Bonding layer | 1.55 | Expression (3) | 142.3 |

| | d | nd |
|---|---|---|
| Substrate | — | — |
| H | 59.9 | 143 |
| L | 22.8 | 27 |
| H | 43.9 | 105 |
| L | 123.6 | 145 |
| H | 55.2 | 132 |
| L | 173.1 | 204 |
| H | 53.5 | 128 |
| L | 194.5 | 229 |
| H | 54.4 | 130 |
| L | 182.2 | 214 |
| H | 55.1 | 132 |
| L | 192.1 | 226 |
| H | 49.9 | 119 |
| L | 167.6 | 197 |
| H | 50.8 | 121 |
| L | 32.6 | 38 |
| H | 36.8 | 88 |
| Bonding layer | — | — |
| Substrate | — | — |

TABLE 8
Fifth exemplary embodiment

| | | | |
|---|---|---|---|
| nb | 1.8 | θc | 30.1 |
| nH | 2.39 | Expression (1) | 41.8 |
| nL | 1.2 | Expression (2) | 184.2 |
| Bonding layer | 1.8 | Expression (3) | 190.6 |

| | d | nd |
|---|---|---|
| Substrate | — | — |
| L | 66.1 | 79 |
| H | 69.9 | 167 |
| L | 135.2 | 162 |
| H | 69.3 | 166 |
| L | 155.9 | 187 |
| H | 68.7 | 164 |
| L | 161 | 193 |
| H | 68.7 | 164 |
| L | 161.6 | 194 |
| H | 68.7 | 164 |
| L | 161.4 | 194 |
| H | 68.7 | 164 |
| L | 157 | 188 |
| H | 69.3 | 166 |
| L | 142.2 | 171 |
| H | 68.5 | 164 |
| L | 73.1 | 88 |
| Bonding layer | — | — |
| Substrate | — | — |

TABLE 9
Sixth exemplary embodiment

| | | | |
|---|---|---|---|
| nb | 1.71 | θc | 30.4 |
| nM | 1.63 | | |
| nH | 2.39 | Expression (1) | 45.0 |
| NL | 1.21 | Expression (2) | 138.3 |
| Bonding layer | 1.71 | Expression (3) | 138 |

| | d | nd |
|---|---|---|
| Substrate | — | — |
| H | 118.5 | 283 |
| M | 117.6 | 192 |
| L | 47.46 | 57 |
| H | 48.69 | 116 |
| M | 27.13 | 44 |
| L | 152.2 | 184 |
| H | 51.82 | 124 |
| M | 12 | 20 |
| L | 189.1 | 229 |
| M | 12 | 20 |
| H | 51.9 | 124 |
| L | 145.7 | 176 |
| M | 34.19 | 56 |
| H | 46.71 | 112 |
| L | 37.22 | 45 |
| M | 184.7 | 301 |
| H | 117.5 | 281 |
| Bonding layer | — | — |
| Substrate | — | — |

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-095114 filed Apr. 21, 2011, which is hereby incorporated by reference herein in its entirety.

What is claimed is:

1. A polarizing beam splitter, comprising:
a medium; and
a polarization splitting film formed of at least two thin-film layers having different refractive indices,
wherein the medium and the at least two film layers are arranged in order from a light incidence side,
wherein the following conditional expressions are satisfied
38°<sin⁻¹(sin(θc)*nH/nb)<52°,
100 nm<ndL<350 nm,
100 nm<ndH/cos(θc)<200 nm, and
θc=cos⁻¹(√(nH²−nL²)/nH),
where nb denotes a refractive index of the medium,
ndH denotes an average value of optical thicknesses nH×dH of the thin-film layers having a refractive index nH where nH is a refractive index and dH is a thickness of a thin-film layer having the highest refractive index out of the thin-film layers,
ndL denotes an average value of optical thicknesses nL×dL of the thin-film layers having a refractive index nL where nL is a refractive index and dL is a thickness of a thin-film layer having the lowest refractive index out of the thin-film layers, and
the average values ndH and ndL are obtained by adding the optical thicknesses of all thin-film layers excluding a layer adjacent to the medium and dividing the sum thereof by the number of thin-film layers.

2. The polarizing beam splitter according to claim 1, wherein the refractive index nL is equal to or lower than 1.30.

3. The polarizing beam splitter according to claim 1, wherein the medium and the thin-film layers are made of an inorganic material.

4. The polarizing beam splitter according to claim 1, wherein the thin-film layer having the refractive index nL is made of at least one material selected from a group including SiO₂, MgF₂, and Al₂O₃.

5. A polarization conversion element comprising:
a medium; and
a polarization splitting film formed of at least two thin-film layers having different refractive indices,
wherein the medium and the at least two film layers are arranged in order from a light incidence side,
wherein the following conditional expressions are satisfied
38°<sin⁻¹(sin(θc)*nH/nb)<52°,
100 nm<ndL<350 nm,
100 nm<ndH/cos(θc)<200 nm, and
θc=cos⁻¹(√(nH²−nL²)/nH),
where nb denotes a refractive index of the medium,
ndH denotes an average value of optical thicknesses nH×dH of the thin-film layers having a refractive index nH where nH is a refractive index and dH is a thickness of a thin-film layer having the highest refractive index out of the thin-film layers,
ndL denotes an average value of optical thicknesses nL×dL of the thin-film layers having a refractive index nL where nL is a refractive index and dL is a thickness of a thin-film layer having the lowest refractive index out of the thin-film layers, and
the average values ndH and ndL are obtained by adding the optical thicknesses of all thin-film layers excluding a layer adjacent to the medium and dividing the sum thereof by the number of thin-film layers.

6. The polarization conversion element according to claim 5, further comprising a λ/2 wave plate configured to rotate the polarization direction of the light incident thereupon by 90°,
wherein the incident P-polarization is converted into the S-polarization, so that the P-polarization is output in the same direction as that of the S-polarization transmitting through the λ/2 wave plate.

7. An image projection apparatus comprising:
a medium; and
a polarization splitting film formed of at least two thin-film layers having different refractive indices,
wherein the medium and the at least two film layers are arranged in order from a light incidence side,
wherein the following conditional expressions are satisfied
38°<sin⁻¹(sin(θc)*nH/nb)<52°,
100 nm<ndL<350 nm,
100 nm<ndH/cos(θc)<200 nm, and
θc=cos⁻¹(√(nH²−nL²)/nH),
where nb denotes a refractive index of the medium,
ndH denotes an average value of optical thicknesses nH×dH of the thin-film layers having a refractive index nH where nH is a refractive index and dH is a thickness of a thin-film layer having the highest refractive index out of the thin-film layers,
ndL denotes an average value of optical thicknesses nL×dL of the thin-film layers having a refractive index nL where nL is a refractive index and dL is a thickness of a thin-film layer having the lowest refractive index out of the thin-film layers, and
the average values ndH and ndL are obtained by adding the optical thicknesses of all thin-film layers excluding a layer adjacent to the medium and dividing the sum thereof by the number of thin-film layers.

8. An image projection apparatus according to claim 7 further comprising:
a projection optical system configured to project an image onto a projection target surface.
